(19) United States
(12) Patent Application Publication
(10) Pub. No.: US 2012/0327070 A1
(43) Pub. Date: Dec. 27, 2012

(54) PLASMA DISPLAY DEVICE, PLASMA DISPLAY SYSTEM, AND CONTROL METHOD FOR SHUTTER GLASSES FOR PLASMA DISPLAY DEVICE

(76) Inventors: Yuya Shiozaki, Osaka (JP); Takahiko Origuchi, Osaka (JP); Mitsuhiro Ishizuka, Osaka (JP)

(21) Appl. No.: 13/582,956

(22) PCT Filed: Mar. 10, 2011
(86) PCT No.: PCT/JP2011/001396

§ 371 Date: Sep. 5, 2012

(30) Foreign Application Priority Data
Mar. 10, 2010 (JP) 2010 052675

(51) Int. Cl. G09G 5/00; G09G 3/28

(52) U.S. Cl. 345/214; 345/60

(57) ABSTRACT

In display of a 3D image on a plasma display panel, the plasma display apparatus achieves an excellent contrast with reduced crosstalk. For this purpose, the plasma display apparatus includes a driver circuit and a control signal generation circuit. The driver circuit drives the plasma display panel in a manner such that a subfield where an all-cell initializing operation is performed in the initializing period and a sustain discharge is caused in all the discharge cells in the sustain period is set as the first subfield of one field. The control signal generation circuit generates shutter opening/closing timing signals that include a timing signal for the right eye and a timing signal for the left eye. The control signal generation circuit sets both of the timing signal for the right eye and the timing signal for the left eye to OFF in the period of the first subfield.

### TECHNICAL FIELD

The present invention relates to a plasma display apparatus, a plasma display system, and a control method for a pair of shutter glasses for the plasma display apparatus that enable the user to stereoscopically view a stereoscopic image formed of an image for the right eye and an image for the left eye alternately displayed on the plasma display panel, using the pair of shutter glasses.

### BACKGROUND ART

In an AC surface discharge panel, i.e. a typical plasma display panel (hereinafter, simply referred to as “panel”), a large number of discharge cells are formed between a front substrate and a rear substrate opposed to each other. In the front substrate, a plurality of display electrode pairs, each including a scan electrode and a sustain electrode, is formed on the glass substrate on the front side. A dielectric layer and a protective layer are formed so as to cover the display electrode pairs.

In the rear substrate, a plurality of parallel data electrodes is formed on the glass substrate on the rear side. A dielectric layer is formed so as to cover these data electrodes. Further, a plurality of barrier ribs is formed in parallel with the data electrodes. Phosphor layers are formed on the surface of the dielectric layer and on the side faces of the barrier ribs.

The front substrate and the rear substrate are faced to each other and sealed such that the display electrode pairs three-dimensionally intersect the data electrodes. In the sealed inside discharge space, a discharge gas containing xenon at a partial pressure ratio of 5% is sealed and discharge cells are formed in parts where the display electrode pairs face the data electrodes. In the thus structured panel, a gas discharge generates ultraviolet rays in each discharge cell, and the ultraviolet rays excite the phosphors of red (R) color, green (G) color, and blue (B) color such that the phosphors emit light for color image display.

A typically used method for driving the panel is a subfield method. In the subfield method, gradations are displayed by dividing one field into a plurality of subfields and causing light emission or no light emission in each discharge cell in each subfield. Each of the subfields has an initializing period, an address period, and a sustain period.

In the initializing period, an initializing operation is performed so as to apply initializing waveforms to the respective scan electrodes and cause an initializing discharge in the respective discharge cells. This operation forms wall charge necessary for the subsequent address operation in the respective discharge cells, and generates priming particles (excitation particles for generating discharge) for stably generating an address discharge.

In the address period, a scan pulse is sequentially applied to the scan electrodes, and an address pulse is applied selectively to the data electrodes based on the signals to be displayed. This operation causes an address discharge between the scan electrodes and the data electrodes in the discharge cells to be lit, and forms wall charge in the discharge cells (hereinafter, these operations being also generically referred to as “addressing”).

In the sustain period, sustain pulses corresponding in number to the luminance weight predetermined for each subfield are alternately applied to the display electrode pairs, each including a scan electrode and a sustain electrode. This operation generates a sustain discharge in the discharge cells having undergone the address discharge, and causes the phosphor layers of the discharge cells to emit light. (Hereinafter, causing a discharge cell to be lit by a sustain discharge is also referred to as “lighting”, and causing a discharge cell not to be lit as “non lighting”.) This operation causes each discharge cell to be lit at a luminance corresponding to the luminance weight. In this manner, the discharge cells of the panel are lit at luminances corresponding to the gradation values of the image signals, so that an image is displayed on the image display area of the panel.

One of the important factors in enhancing the image display quality in a panel is to enhance the contrast. One of the subfield methods discloses a driving method for enhancing the contrast ratio by minimizing the light emission unrelated to gradation display.

In this driving method, in the initializing period of one of a plurality of subfields forming one field, an initializing operation is performed so as to cause an initializing discharge in all the discharge cells. In the initializing periods of the other subfields, an initializing operation is performed so as to cause an initializing discharge selectively in the discharge cells having undergone a sustain discharge in the sustain period of the immediately preceding subfield.

The luminance of a black display area where no sustain discharge occurs (hereinafter, simply referred to as “luminance of black level”) is changed by the light emission unrelated to image display, such as a light emission caused by an initializing discharge. In the above driving method, the light emission in the black display area is only the weak light emission caused when the initializing operation is performed in all the discharge cells. This operation allows the display of an image of high contrast by reducing the luminance of black level (see Patent Literature 1, for example).

Considerations are made on the display of three-dimensional images (hereinafter, referred to as “3D images”) that allow stereoscopic view on the panel, and the use of the plasma display apparatus as a 3D image display apparatus.

One 3D image is formed of one image for the right eye and one image for the left eye. This plasma display apparatus alternately displays the image for the right eye and the image for the left eye when a 3D image is displayed on the panel.

The user views the 3D image displayed on the panel, using special glasses called a pair of shutter glasses where the right shutter and the left shutter alternately open and close in synchronization with a field for display of the image for the right eye and a field for display of the image for the left eye, respectively.

A pair of shutter glasses includes a shutter for the right eye and a shutter for the left eye. In the period during which an image for the right eye is displayed on the panel, the right eye shutter is opened (in a state of transmitting visible light) and the left eye shutter is closed (in a state of blocking visible light). In the period during which an image for the left eye is displayed, the left eye shutter is opened and the right eye shutter is closed. This operation enables the user to view the image for the right eye only with the right eye, and the image for the left eye only with the left eye. Thus, the user can stereoscopically view the 3D image displayed on the panel.

One 3D image is formed of one image for the right eye and one image for the left eye. For this reason, when a 3D image is displayed, a half of the images displayed on the panel per unit time (e.g. per second) are images for the right eye, and the remaining half of the images are images for the left eye. Thus, the number of 3D images displayed on the panel per second is a half the field frequency (the number of fields generated per second). When the number of images displayed on the panel per unit time decreases, flickering called flickers in the image is likely to be observed.

When images other than 3D images, i.e. general images (hereinafter, “2D images”) where an image for the right eye and an image for the left eye are not discriminated, are displayed on the panel, 60 images are displayed on the panel per second at a field frequency of 60 Hz, for example. Thus, in order to display 3D images equal in number (e.g. 60 images per second) to 2D images on the panel per unit time, the field frequency of the 3D images (e.g. 120 Hz) needs to be set twice the field frequency of 2D images.

As one of the methods for stereoscopically viewing a 3D image in a plasma display apparatus, the following method is disclosed (see Patent Literature 2, for example). A plurality of subfields is divided into a subfield group where images for the right eye are displayed and a subfield group where images for the left eye are displayed. In synchronization with the start of the address period of the first subfield in each subfield group, the shutters of a pair of shutter glasses are opened and closed.

With increases in the screen size and definition of the panel, further enhancement of the image display quality is requested. Also in the plasma display apparatus usable as a 3D image display apparatus, high image display quality is requested.

### CITATION LIST

### Patent Literature

PTL1

Japanese Patent Unexamined Publication No. 2000-242224

PTL2

Japanese Patent Unexamined Publication No. 2000-112428

### SUMMARY OF THE INVENTION

A plasma display apparatus of the present invention includes the following elements:
a panel having a plurality of discharge cells, each of the discharge cells having a display electrode pair, the display electrode pair including a scan electrode and a sustain electrode;
a driver circuit for displaying an image on the panel by alternately repeating a field for the right eye for display of an image signal for the right eye and a field for the left eye for display of an image signal for the left eye based on the image signals including an image signal for the right eye and an image signal for the left eye, in a manner such that a plurality of subfields, each having an initializing period, an address period, and a sustain period, forms one field, and a subfield where an up-ramp waveform voltage is applied to the scan electrodes in the initializing period and a sustain discharge is caused in all the discharge cells in the sustain period is set as the first subfield of the one field; and
a control signal generation circuit for generating shutter opening/closing timing signals that include a timing signal for the right eye and a timing signal for the left eye, the timing signal for the right eye being set to ON when the field for the right eye is displayed on the panel and to OFF when the field for the left eye is displayed, the timing signal for the left eye being set to ON when the field for the left eye is displayed and to OFF when the field for the right eye is displayed.

In the period of the first subfield, the control signal generation circuit generates the shutter opening/closing timing signals that set both of the timing signal for the right eye and the timing signal for the left eye to OFF.

This configuration can stabilize the address operation when a 3D image is displayed on the panel of a plasma display apparatus usable as a 3D image display apparatus, and provide a 3D image of excellent contrast with reduced crosstalk to the user who views the display image through a pair of shutter glasses.

The driver circuit in the plasma display apparatus of the present invention may be configured so as to generate sustain pulses equal in number to the luminance weight multiplied by a luminance magnification in the sustain periods of the subfields except the first subfield and generate a fixed number of sustain pulses regardless of the luminance magnification in the sustain period of the first subfield.

The driver circuit in the plasma display apparatus of the present invention may be configured so as not to perform address operation in the address period of the first subfield. This structure can shorten the time taken for the first subfield in 3D driving.

A plasma display system of the present invention includes the following elements:
a plasma display apparatus including the following elements:
   a panel having a plurality of discharge cells, each of the discharge cells having a display electrode pair, the display electrode pair including a scan electrode and a sustain electrode;
   a driver circuit for displaying an image on the panel by alternately repeating a field for the right eye for display of an image signal for the right eye and a field for the left eye for display of an image signal for the left eye based on the image signals including an image signal for the right eye and an image signal for the left eye, in a manner such that a plurality of subfields, each having an initializing period, an address period, and a sustain period, forms one field, and a subfield where an up-ramp waveform voltage is applied to the scan electrodes in the initializing period and a sustain discharge is caused in all the discharge cells in the sustain period is set as the first subfield of the one field; and
   a control signal generation circuit for generating shutter opening/closing timing signals that include a timing signal for the right eye and a timing signal for the left eye, the timing signal for the right eye being set to ON when the field for the right eye is displayed on the panel and to OFF when the field for the left eye is displayed, the timing signal for the left eye being set to ON when the field for the left eye is displayed and to OFF when the field for the right eye is displayed; and
a pair of shutter glasses, the shutter glasses including a right eye shutter and a left eye shutter that can be opened and closed independently, opening/closing of the shutters being controlled by the shutter opening/closing timing signals generated in the control signal generation circuit.
   In the period of the first subfield, both of the right eye shutter and the left eye shutter are in a closed state.

When a 3D image is displayed on the panel of a plasma display apparatus usable as a 3D image display apparatus included in a plasma display system, this configuration can stabilize the address operation and provide a 3D image of excellent contrast with reduced crosstalk to the user who views the display image through the pair of shutter glasses.

In a control method for a pair of shutter glasses for a plasma display apparatus,
the pair of shutter glasses being used to view an image displayed on the plasma display apparatus and having a right eye shutter and a left eye shutter that can be opened and closed independently,
the plasma display apparatus including:
   a panel having a plurality of discharge cells, each of the discharge cells having a display electrode pair, the display electrode pair including a scan electrode and a sustain electrode;
   a driver circuit for displaying an image on the panel by alternately repeating a field for the right eye for display of an image signal for the right eye and a field for the left eye for display of an image signal for the left eye based on the image signals including an image signal for the right eye and an image signal for the left eye, in a manner such that a plurality of subfields, each having an initializing period, an address period, and a sustain period, forms one field, and a subfield where an up-ramp waveform voltage is applied to the scan electrodes in the initializing period and a sustain discharge is caused in all the discharge cells in the sustain period is set as the first subfield of the one field; and
   a control signal generation circuit for generating shutter opening/closing timing signals that include a timing signal for the right eye and a timing signal for the left eye, the timing signal for the right eye being set to ON when the field for the right eye is displayed on the panel and to OFF when the field for the left eye is displayed on the panel, the timing signal for the left eye being set to ON when the field for the left eye is displayed and to OFF when the field for the right eye is displayed,

the control method includes:
controlling the pair of shutter glasses such that both of the right eye shutter and the left eye shutter are in a closed state in the period of the first subfield.

Thus, when a plasma display apparatus that is usable as a 3D image display apparatus and capable of stabilizing the address operation in display of a 3D image on the panel is viewed with a pair of shutter glasses to be controlled by this control method, the user can view the 3D image displayed on the panel as an image of high display quality where contrast is enhanced by reducing the luminance of black level while crosstalk is reduced.

### BRIEF DESCRIPTION OF DRAWINGS

FIG. 1 is an exploded perspective view showing a structure of a panel for use in a plasma display apparatus in accordance with an exemplary embodiment of the present invention.

FIG. 2 is an electrode array diagram of the panel for use in the plasma display apparatus in accordance with the exemplary embodiment.

FIG. 3 shows a circuit block diagram of the plasma display apparatus and a schematic diagram outlining a plasma display system in accordance with the exemplary embodiment.

FIG. 4 is a chart schematically showing driving voltage waveforms applied to respective electrodes of the panel for use in the plasma display apparatus in accordance with the exemplary embodiment.

FIG. 5 is a waveform chart schematically showing driving voltage waveforms applied to the respective electrodes of the panel for use in the plasma display apparatus and an opening/closing operation of a pair of shutter glasses in accordance with the exemplary embodiment.

FIG. 6 is a diagram schematically showing a subfield structure in display of a 3D image in the plasma display apparatus, and opening/closing states of a right eye shutter and a left eye shutter in accordance with the exemplary embodiment.

### DESCRIPTION OF EMBODIMENTS

Hereinafter, a plasma display apparatus and plasma display system in accordance with an exemplary embodiment of the present invention are described with reference to the accompanying drawings.

### Exemplary Embodiment

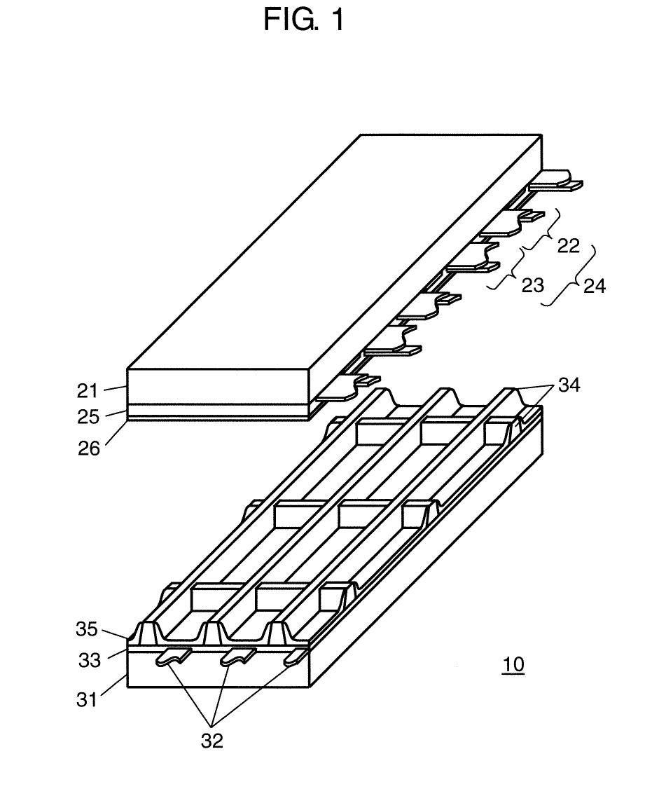

FIG. 1 is an exploded perspective view showing a structure of panel 10 for use in the plasma display apparatus in accordance with the exemplary embodiment of the present invention. A plurality of display electrode pairs 24, each including scan electrode 22 and sustain electrode 23, is disposed on glass front substrate 21. Dielectric layer 25 is formed so as to cover scan electrodes 22 and sustain electrodes 23. Protective layer 26 is formed over dielectric layer 25.

In order to lower the discharge start voltage in the discharge cells, protective layer 26 is formed of a material predominantly composed of magnesium oxide (MgO). MgO has proven performance as a panel material, and has a large secondary electron emission coefficient and excellent durability when neon (Ne) and xenon (Xe) gas is sealed.

A plurality of data electrodes 32 is formed on rear substrate 31. Dielectric layer 33 is formed so as to cover data electrodes 32, and mesh barrier ribs 34 are formed on the dielectric layer. On the side faces of barrier ribs 34 and on dielectric layer 33, phosphor layers 35 for emitting light of red (R) color, green (G) color, and blue (B) color are formed.

In this exemplary embodiment, BaMgAl₁₀O₁₇:Eu is used as a blue phosphor, Zn₂SiO₄:Mn is used as a green phosphor, and (Y, Gd) BO₃:Eu is used as a red phosphor. However, in the present invention, the phosphors that form phosphor layers 35 are not limited to the above phosphors. The time constants with which the afterglow of the phosphors attenuates vary with the materials of the phosphors. The time constants are equal to or shorter than approximately 1 msec for the blue phosphor, approximately 2 msec to 5 msec for the green phosphor, and approximately 3 msec to 4 msec for the red phosphor. For example, in this exemplary embodiment, the time constant of the blue phosphor is approximately 0.1 msec, and those of the green phosphor and the red phosphor are approximately 3 msec. This time constant is a time taken for the afterglow to attenuate to approximately 10% of the emission luminance (peak luminance) at the occurrence of the discharge after the completion of the discharge.

Front substrate 21 and rear substrate 31 face each other such that display electrode pairs 24 intersect data electrodes 32 with a small discharge space sandwiched between the electrodes. The outer peripheries of the substrates are sealed with a sealing material, such as a glass frit. In the inside discharge space, a neon/xenon mixture gas, for example, is sealed as a discharge gas.

The discharge space is partitioned into a plurality of compartments by barrier ribs 34. Discharge cells are formed in the intersecting parts of display electrode pairs 24 and data electrodes 32.

The discharge cells cause a discharge and the discharge causes phosphor layers 35 of the discharge cells to emit light (lights the discharge cells), so that a color image is displayed on panel 10.

In panel 10, three consecutive discharge cells arranged in the extending direction of display electrode pair 24, i.e. a discharge cell for emitting light of red (R) color, a discharge cell for emitting light of green (G) color, and a discharge cell for emitting light of blue (B) color, form one pixel.

The structure of panel 10 is not limited to the above, and may include barrier ribs in a stripe pattern, for example.

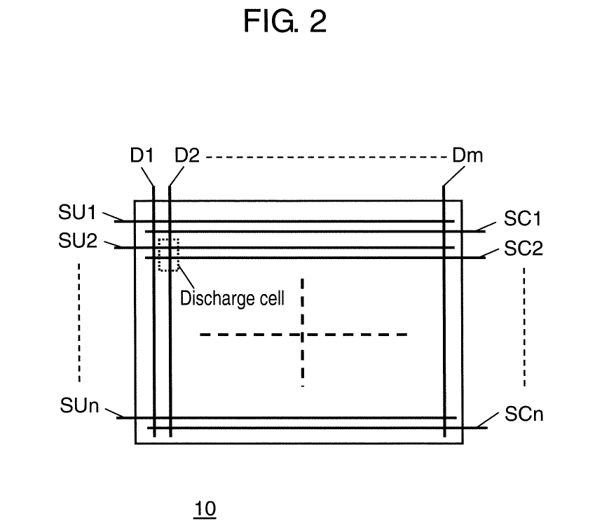

FIG. 2 is an electrode array diagram of panel 10 for use in the plasma display apparatus in accordance with the exemplary embodiment of the present invention. Panel 10 has n scan electrode SC1-scan electrode SCn (scan electrodes 22 in FIG. 1) and n sustain electrode SC1-sustain electrode SUn (sustain electrodes 23 in FIG. 1) both elongated in the horizontal direction (line direction), and m data electrode D1-data electrode Dm (data electrodes 32 in FIG. 1) elongated in the vertical (column) direction. A discharge cell is formed in the part where a pair of scan electrode SCi (i=1-n) and sustain electrode SUi intersects one data electrode Dj (j=1-m). That is, one display electrode pair 24 has m discharge cells, which form m/3 pixels. Then, m×n discharge cells are formed in the discharge space, and the area having m×n discharge cells is the image display area of panel 10. For example, in a panel having 1920×1080 pixels, m=1920×3 and n=1080.

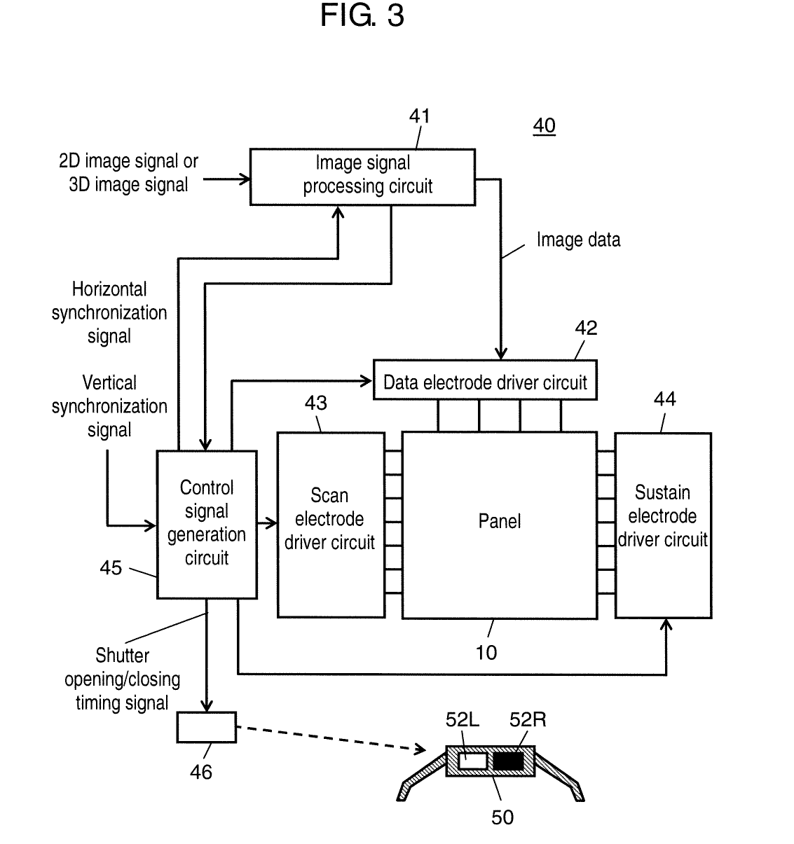

FIG. 3 shows a circuit block diagram of plasma display apparatus 40 and a schematic diagram outlining a plasma display system in accordance with the exemplary embodiment of the present invention. The plasma display system of this exemplary embodiment includes plasma display apparatus 40 and pair of shutter glasses 50 as the elements.

Plasma display apparatus 40 includes the following elements:
panel 10 having a plurality of discharge cells arranged therein, each of the discharge cells having scan electrode 22, sustain electrode 23, and data electrode 32; and
a driver circuit for driving panel 10.

The driver circuit includes image signal processing circuit 41; data electrode driver circuit 42; scan electrode driver circuit 43; sustain electrode driver circuit 44; control signal generation circuit 45; and electric power supply circuits (not shown) for supplying electric power necessary for each circuit block.

The driver circuit drives panel 10 in one of 3D driving and 2D driving. In 3D driving, a 3D image is displayed on panel 10 by alternately repeating a field for the right eye and a field for the left eye based on 3D image signals. In 2D driving, a 2D image is displayed on panel 10 based on 2D image signals where an image signal for the right eye and an image signal for the left eye are not discriminated. Plasma display apparatus 40 includes timing signal output part 46 that outputs shutter opening/closing timing signals for controlling the opening/closing of the shutters of pair of shutter glasses 50 used by the user. Pair of shutter glasses 50 is used by the user when a 3D image is displayed on panel 10. The user can stereoscopically view a 3D image by perceiving them through pair of shutter glasses 50.

Image signal processing circuit 41 receives a 2D image signal or a 3D image signal, and allocates gradation values to each discharge cell, based on the input image signal. The image signal processing circuit converts the gradation values into image data representing light emission and no light emission (data where light emission and no light emission correspond to digital signals “1” and “0”, respectively) in each subfield. That is, image signal processing circuit 41 converts the image signals in each field into image data representing light emission and no light emission in each subfield.

For instance, when the input image signal includes an R signal, a G signal, and a B signal, R, G, and B gradation values are allocated to the respective discharge cells, based on the R signal, G signal, and B signal. When input image signal includes a luminance signal (Y signal) and a chroma signal (C signal, R-Y signal and B-Y signal, u signal and v signal, or the like), the R signal, G signal, and B signal are calculated based on the luminance signal and the chroma signal, and thereafter the R, G, and B gradation values (gradation values represented in one field) are allocated to the respective discharge cells. Then, the R, G, and B gradation values allocated to the respective discharge cells are converted into image data representing light emission and no light emission in each subfield. When the input image signal is a 3D image signal for stereoscopic view that includes an image signal for the right eye and an image signal for the left eye and the 3D image signal is displayed on panel 10, the image signal for the right eye and the image signal for the left eye are alternately input to image signal processing circuit 41 in each field. Thus, image signal processing circuit 41 converts the image signal for the right eye into image data for the right eye, and the image signal for the left eye into image data for the left eye.

Control signal generation circuit 45 determines that which of a 2D image signal and a 3D image signal is input into plasma display apparatus 40, based on the input signal. Based on the determination result, the control signal generation circuit generates a control signal for controlling each driver circuit so that the 2D image or the 3D image is displayed on panel 10.

Specifically, control signal generation circuit 45 determines whether the input signal into plasma display apparatus 40 is a 3D image signal or a 2D image signal, based on the frequencies of a horizontal synchronization signal and a vertical synchronization signal in the input signal. For example, when the horizontal synchronization signal is at 33.75 kHZ and the vertical synchronization signal is at 60 Hz, the input signal is determined as a 2D image signal. When the horizontal synchronization signal is at 67.5 kHZ and the vertical synchronization signal is at 120 Hz, the input signal is determined as a 3D image signal. Based on the horizontal synchronization signal and vertical synchronization signal, various control signals for controlling the operation of each circuit block are generated. Then, the generated control signals are supplied to each circuit block (data electrode driver circuit 42, scan electrode driver circuit 43, sustain electrode driver circuit 44, and image signal processing circuit 41, or the like).

When a 3D image is displayed on panel 10, control signal generation circuit 45 outputs shutter opening/closing timing signals for controlling the opening/closing of the shutters of pair of shutter glasses 50, to timing signal output part 46. Control signal generation circuit 45 sets a shutter opening/closing timing signal to ON (“1”) when the shutter of pair of shutter glasses 50 is opened (in a state of transmitting visible light). The control signal generation circuit sets the shutter opening/closing timing signal to OFF (“0”) when the shutter of pair of shutter glasses 50 is closed (in a state of blocking visible light).

The shutter opening/closing timing signals include two types of timing signals: a timing signal for the right eye (a timing signal for opening/closing the right eye shutter) that is set to ON when a field for the right eye is displayed on panel 10 based on an image signal for the right eye of the 3D image, and is set to OFF when a field for the left eye is displayed based on an image signal for the left eye; and a timing signal for a left eye (a timing signal for opening/closing the left eye shutter) that is set to ON when a field for the left eye is displayed based on an image signal for the left eye of the 3D image, and is set to OFF when a field for the right eye based on an image signal for the right eye is displayed.

In this exemplary embodiment, the frequencies of the horizontal synchronization signal and the vertical synchronization signal are not limited to the above numerical values. When a determination signal for determining a 2D image signal or a 3D image signal is added to the input signal, control signal generation circuit 45 may determine which of the 2D image signal and the 3D signal is input, based on the determination signal.

Scan electrode driver circuit 43 has an initializing waveform generation circuit, a sustain pulse generation circuit, and a scan pulse generation circuit (not shown in FIG. 3). The scan electrode driver circuit generates the driving voltage waveforms based on the control signal supplied from control signal generation circuit 45, and applies the waveforms to each of scan electrode SC1-scan electrode SCn. Based on the control signal, the initializing waveform generation circuit generates an initializing waveform to be applied to scan electrode SC1-scan electrode SCn in the initializing periods.

Based on the control signal, the sustain pulse generation circuit generates a sustain pulse to be applied to scan electrode SC1-scan electrode SCn in the sustain periods. The scan pulse generation circuit has a plurality of scan electrode driver ICs (scan ICs). Based on the control signal, the scan pulse generation circuit generates a scan pulse to be applied to scan electrode SC1-scan electrode SCn in the address periods.

Sustain electrode driver circuit 44 has a sustain pulse generation circuit and a circuit for generating voltage Ve1 and voltage Ve2 (not shown in FIG. 3), generates driving voltage waveforms based on the control signal supplied from control signal generation circuit 45, and applies the driving voltage waveforms to each of sustain electrode SU1-sustain electrode SUn. In the sustain period, based on the control signal, sustain pulses are generated and applied to sustain electrode SU1-sustain electrode SUn.

Data electrode driver circuit 42 converts data in each subfield into a signal corresponding to each of data electrode D1-data electrode Dm. The above data includes image data based on a 2D image signal, or image data for the right eye and image data for the left eye based on 3D image signals. Then, based on the signals corresponding to the data electrodes, and the control signal supplied from control signal generation circuit 45, the data electrode driver circuit drives each of data electrode D1-data electrode Dm. In the address period, the data electrode driver circuit generates an address pulse and applies the address pulse to each of data electrode D1-data electrode Dm.

Timing signal output part 46 includes a light-emitting element, such as a light-emitting diode (LED), and supplies shutter opening/closing timing signals to pair of shutter glasses 50 as those converted into infrared signals, for example.

Pair of shutter glasses 50 has a signal receiver (not shown) for receiving a signal (e.g. an infrared signal) output from timing signal output part 46, right eye shutter 52R, and left eye shutter 52L. Right eye shutter 52R and left eye shutter 52L can be opened and closed independently. In pair of shutter glasses 50, right eye shutter 52R and left eye shutter 52L are opened and closed in response to shutter opening/closing timing signals that are supplied from timing signal output part 46.

Right eye shutter 52R opens (transmits visible light) when the timing signal for the right eye is set to ON, and closes (blocks visible light) when that timing signal is set to OFF. Left eye shutter 52L opens (transmits visible light) when the timing signal for the left eye is set to ON, and closes (blocks visible light) when that timing signal is set to OFF.

Right eye shutter 52R and left eye shutter 52L can be formed of liquid crystal, for example. However, in the present invention, the material making up the shutters is not limited to liquid crystal. As long as blocking and transmission of visible light can be switched at a high speed, any material may be used.

Next, driving voltage waveforms for driving panel 10 and the operation thereof are outlined.

Plasma display apparatus 40 of this exemplary embodiment drives panel 10 by a subfield method. In the subfield method, one field is divided into a plurality of subfields along a temporal axis, and a luminance weight is set for each subfield. Each of the fields has a plurality of subfields. Each of the subfields has an initializing period, an address period, and a sustain period.

In the initializing period, an initializing discharge is caused in the discharge cells so as to form wall charge necessary for the address discharge in the subsequent address period on the respective electrodes.

In the address period, an address operation is performed in the following manner. A scan pulse is applied to scan electrodes 22 and an address pulse is applied selectively to data electrodes 32 so as to cause an address discharge selectively in the discharge cells to be lit and form wall charge for causing a sustain discharge in the subsequent sustain period in the discharge cells.

In the sustain period, sustain pulses corresponding in number to the luminance weight predetermined for each subfield multiplied by a predetermined proportionality factor are alternately applied to scan electrodes 22 and sustain electrodes 23 so as to perform a sustain operation for causing a sustain discharge and emitting light in the discharge cells having undergone an address discharge in the immediately preceding address period. This proportionality factor is a luminance magnification.

The luminance weight represents a ratio of the magnitudes of luminance displayed in the respective subfields. In the sustain period of each subfield, sustain pulses corresponding in number to the luminance weight are generated. Thus, for example, the luminance of the light emission in the subfield having the luminance weight “8” is approximately eight times as high as that in the subfield having the luminance weight “1”, and is approximately four times as high as that in the subfield having the luminance weight “2”.

For example, when the luminance magnification is 2, in the sustain period of a subfield having the luminance weight “2”, four sustain pulses are applied to each of scan electrodes 22 and sustain electrodes 23. Thus, the number of sustain pulses generated in the sustain period is 8.

Thus, the selective light emission caused by control of light emission and no light emission in each discharge cell in each subfield in combination in response to image signals allows the display of various gradations and an image on panel 10.

The initializing operations include two types: an all-cell initializing operation for causing an initializing discharge in the discharge cells regardless of the operation in the immediately preceding subfield; and a selective initializing operation for causing an initializing discharge selectively in the discharge cells having undergone an address discharge in the address period and undergone a sustain discharge in the sustain period in the immediately preceding subfield. In the all-cell initializing operation, a rising up-ramp waveform voltage and a falling down-ramp waveform voltage are applied to scan electrodes 22 so as to cause an initializing discharge in all the discharge cells in the image display area. In the initializing period of one of the plurality of subfields, an all-cell initializing operation is performed (hereinafter, the initializing period where an all-cell initializing operation is performed being referred to as “all-cell initializing period”, the subfield including an all-cell initializing period being referred to as “all-cell initializing subfield”). In the initializing periods of the other subfields, a selective initializing operation is performed (hereinafter, the initializing period where a selective initializing operation is performed being referred to as “selective initializing period”, and the subfield including a selective initializing period being referred to as “selective initializing subfield”).

In this exemplary embodiment, only the first subfield of each field (the subfield occurring first in the field) is an all-cell initializing subfield. That is, an all-cell initializing operation is performed in the initializing period of the first subfield (subfield SF1), and a selective initializing operation is performed in the initializing periods of the other subfields. This operation can cause an initializing discharge in all the discharge cells at least once in one field, thus stabilizing the address operation after the all-cell initializing operation. The light emission unrelated to image display is the light emission caused by the discharge in the all-cell initializing operation in subfield SF1. Therefore, the luminance of black level, i.e. the luminance of a black display area where no sustain discharge occurs, is only weak light emission in the all-cell initializing operation. Thus, an image of high contrast can be displayed on panel 10.

However, in this exemplary embodiment, the number of subfields forming one field, or the luminance weights of the respective subfields is not limited to the above values. Alternatively, the subfield structure may be switched in response to an image signal, for example.

In this exemplary embodiment, the image signal input into plasma display apparatus 40 is a 2D image signal or a 3D image signal. In response to the respective image signals, plasma display apparatus 40 drives panel 10. First, a description is provided for the driving voltage waveforms to be applied to the respective electrodes of panel 10 when a 2D image signal is input into plasma display apparatus 40. Next, a description is provided for the driving voltage waveforms to be applied to the respective electrodes of panel 10 when a 3D image signal is input into plasma display apparatus 40.

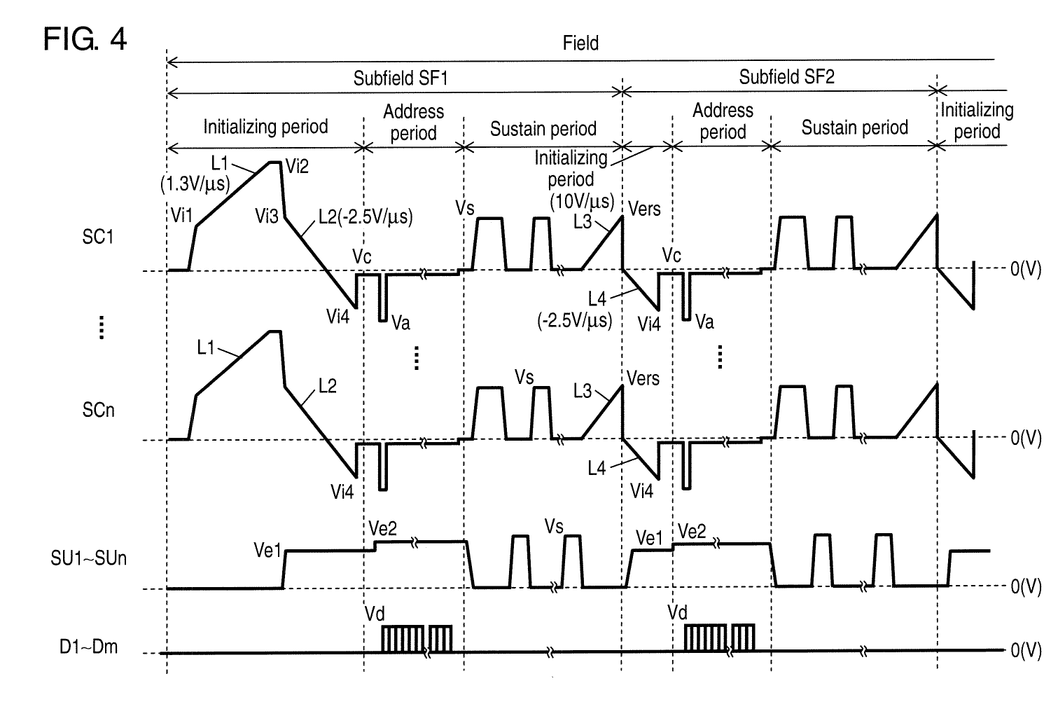

FIG. 4 is a chart schematically showing driving voltage waveforms applied to respective electrodes of panel 10 for use in the plasma display apparatus in accordance with the exemplary embodiment of the present invention. FIG. 4 shows driving voltage waveforms applied to the following electrodes: scan electrode SC1 for undergoing an address operation first in the address periods; scan electrode SCn for undergoing an address operation last in the address periods; sustain electrode SUI-sustain electrode SUn; and data electrode D1-data electrode Dm. Scan electrode SCi, sustain electrode SUi, and data electrode Dk in the following description are the electrodes selected from the respective electrodes, based on image data (data representing the light emission and no light emission in each subfield).

FIG. 4 shows driving voltage waveforms in two subfields: subfield SF1 and subfield SF2. Subfield SF1 is a subfield where an all-cell initializing operation is performed. Subfield SF2 is a subfield where a selective initializing operation is performed. Therefore, in subfield SF1 and subfield SF2, the waveform shapes of driving voltage applied to scan electrodes 22 in the initializing periods are different. The driving voltage waveforms in the other subfields are substantially similar to those in subfield SF2 except for the numbers of sustain pulses in the sustain periods.

For plasma display apparatus 40 of this exemplary embodiment, a description is provided of an example where one field is formed of eight subfields (subfield SF1, subfield SF2 . . . subfield SF8) and luminance weights of 1, 2, 4, 8, 16, 32, 64, and 128 are set for the respective subfield SF1-subfield SF8 when panel 10 is driven by a 2D image signal.

In this manner, in this exemplary embodiment, when panel 10 is driven by a 2D image signal, luminance weights are set such that subfield SF1 occurring first in the field is a subfield having the smallest luminance weight, the subfields thereafter have the luminance weights sequentially increasing, and subfield SF8 occurring last in the field is a subfield having the largest luminance weight.

In this exemplary embodiment, the number of subfields forming one field and the luminance weight of each subfield are not limited to the above values.

First, a description is provided for subfield SF1, i.e. an all-cell initializing subfield.

First, subfield SF1 is described.

In the first half of the initializing period of subfield SF1 where an all-cell initializing operation is performed, voltage 0 (V) is applied to each of data electrode D1-data electrode Dm and sustain electrode SU1-sustain electrode SUn. Voltage 0 (V) and then Voltage Vi1 are applied to scan electrode SC1-scan electrode SCn. Next, an up-ramp waveform voltage (hereinafter, referred to as “ramp voltage L1”) gently rising from voltage Vi1 toward voltage Vi2 (with a gradient of 1.3 V/μsec, for example) is applied to scan electrode SC1-scan electrode SCn. Voltage Vi1 is set to a voltage lower than a discharge start voltage with respect to sustain electrode SU1-sustain electrode SUn. Voltage Vi2 is set to a voltage exceeding the discharge start voltage.

While up-ramp voltage L1 is rising, a weak initializing discharge continuously occurs between scan electrode SC1-scan electrode SCn and sustain electrode SU1-sustain electrode SUn, and between scan electrode SC1-scan electrode SCn and data electrode D1-data electrode Dm in the respective discharge cells. Then, negative wall voltage accumulates on scan electrode SC1-scan electrode SCn, and positive wall voltage accumulates on data electrode D1-data electrode Dm and sustain electrode SU1-sustain electrode SUn. This wall voltage on the electrodes means voltages that are generated by the wall charge accumulated on the dielectric layers covering the electrodes, the protective layer, the phosphor layers, or the like.

In the second half of the initializing period of subfield SF1, positive voltage Ve1 is applied to sustain electrode SU1-sustain electrode SUn, and voltage 0 (V) is applied to data electrode D1-data electrode Dm. A down-ramp waveform voltage (hereinafter, “ramp voltage L2”) gently falling from voltage Vi3 toward negative voltage Vi4 (with a gradient of −2.5 V/μsec, for example) is applied to scan electrode SC1-scan electrode SCn. Voltage Vi3 is set to a voltage lower than the discharge start voltage with respect to sustain electrode SU1-sustain electrode SUn, and voltage Vi4 is set to a voltage exceeding the discharge start voltage.

While this ramp voltage L2 is applied to scan electrode SC1-scan electrode SCn, a weak initializing discharge occurs between scan electrode SC1-scan electrode SCn and sustain electrode SU1-sustain electrode SUn, and between scan electrode SC1-scan electrode SCn and data electrode D1-data electrode Dm in the respective discharge cells. This weak discharge reduces the negative wall voltage on scan electrode SC1-scan electrode SCn and the positive wall voltage on sustain electrode SU1-sustain electrode SUn, and adjusts the positive wall voltage on data electrode D1-data electrode Dm to a value appropriate for the address operation.

In this manner, the initializing operation in the initializing period of subfield SF1, i.e. the all-cell initializing operation for forcedly causing an initializing discharge in all the discharge cells, is completed and the wall charge necessary for the subsequent address operation is formed on the respective electrodes in all the discharge cells.

In the subsequent address period of subfield SF1, voltage Ve2 is applied to sustain electrode SU1-sustain electrode SUn, and voltage Vc (where voltage Vc=voltage Va+voltage Vscn) is applied to scan electrode SC1-scan electrode SCn.

Next, a scan pulse of negative polarity at negative voltage Va is applied to scan electrode SC1 in the first line, which undergoes the address operation first. Further, an address pulse of positive polarity at positive voltage Vd is applied to data electrode Dk of a discharge cell to be lit in the first line among data electrode D1-data electrode Dm.

Thus, the voltage difference in the intersecting part of data electrode Dk and scan electrode SC1 in the discharge cell applied with the address pulse at voltage Vd is obtained by adding the difference between the wall voltage on data electrode Dk and the wall voltage on scan electrode SC1 to a difference in externally applied voltage (voltage Vd-voltage Va). Thus, the voltage difference between data electrode Dk and scan electrode SC1 exceeds the discharge start voltage, and a discharge occurs between data electrode Dk and scan electrode SC1.

Since voltage Ve2 is applied to sustain electrode SU1-sustain electrode SUn, the voltage difference between sustain electrode SU1 and scan electrode SC1 is obtained by adding the difference between the wall voltage on sustain electrode SU1 and the wall voltage on scan electrode SC1 to a difference in externally applied voltage (voltage Ve2−voltage Va). At this time, setting voltage Vet to a voltage value slightly lower than the discharge start voltage can make the state where a discharge is likely to occur but does not actually occurs between sustain electrode SU1 and scan electrode SC1.

With this setting, a discharge occurring between data electrode Dk and scan electrode SC1 can trigger a discharge between the areas of sustain electrode SU1 and scan electrode SC1 intersecting data electrode Dk. Thus, an address discharge occurs in the discharge cell (the discharge cell to be lit) having undergone the scan pulse and the address pulse at the same time. Positive wall voltage accumulates on scan electrode SC1, and negative wall voltage accumulates on sustain electrode SU1. Negative wall voltage also accumulates on data electrode Dk.

In this manner, address operation in the discharge cells in the first line is completed. In contrast, the voltage in the intersecting parts of scan electrode SC1 and data electrodes 32 applied with no address pulse does not exceed the discharge start voltage, and thus no address discharge occurs.

Next, a scan pulse is applied to scan electrode SC2 in the second line, and an address pulse is applied to data electrode Dk corresponding to a discharge cell to be lit in the second line. Thus, an address operation is performed on the discharge cells in the second line.

The above address operation is sequentially performed on scan electrode SC3, scan electrode SC4 . . . scan electrode SCn in this order until the operation reaches the discharge cells in the n-th line. Thus, the address period of subfield SF1 is completed. In this manner, in the address period, an address discharge is selectively caused in the discharge cells to be lit so as to form wall charge in the discharge cells.

In the subsequent sustain period of subfield SF1, a base electric potential, i.e. voltage 0 (V), is applied to sustain electrode SU1-sustain electrode SUn, and a sustain pulse at positive voltage Vs is applied to scan electrode SC1-scan electrode SCn.

With the application of this sustain pulse, in the discharge cells having undergone the address discharge, the voltage difference between scan electrode SCi and sustain electrode SUi is obtained by adding the difference between the wall voltage on scan electrode SCi and the wall voltage on sustain electrode SUi to sustain pulse voltage Vs.

Thus, the voltage difference between scan electrode SCi and sustain electrode SUi exceeds the discharge start voltage and a sustain discharge occurs between scan electrode SCi and sustain electrode SUi. Ultraviolet rays generated by this discharge cause phosphor layers 35 to emit light. With this discharge, negative wall voltage accumulates on scan electrode SCi, and positive wall voltage accumulates on sustain electrode SUi. Positive wall voltage also accumulates on data electrode Dk. In the discharge cells having undergone no address discharge in the address period, no sustain discharge occurs.

Subsequently, voltage 0 (V) is applied to scan electrode SC1-scan electrode SCn, and a sustain pulse at voltage Vs is applied to sustain electrode SU1-sustain electrode SUn. In the discharge cells having undergone the sustain discharge, the voltage difference between sustain electrode SUi and scan electrode SCi exceeds the discharge start voltage. Thereby, a sustain discharge occurs between sustain electrode SUi and scan electrode SCi again. Negative wall voltage accumulates on sustain electrode SUi, and positive wall voltage accumulates on scan electrode SCi.

Similarly, sustain pulses corresponding in number to the luminance weight multiplied by a predetermined luminance magnification are alternately applied to scan electrode SC1-scan electrode SCn and sustain electrode SU1-sustain electrode SUn. By giving a potential difference between the electrodes of each display electrode pair 24 in this manner, the sustain discharge is continued in the discharge cells having undergone the address discharge in the address period.

After the sustain pulses have been generated in the sustain period (at the end of the sustain period), a ramp waveform voltage (hereinafter, “erasing ramp voltage L3”) gently rising (with a gradient of approximately 10 V/μsec) from voltage 0 (V) as the base electric potential toward voltage Vers is applied to scan electrode SC1-scan electrode SCn while voltage 0 (V) is applied to sustain electrode SU1-sustain electrode SUn and data electrode D1-data electrode Dm.

While erasing ramp voltage L3 applied to scan electrode SC1-scan electrode SCn is rising higher than the discharge start voltage, a weak discharge continuously occurs in the discharge cells having undergone a sustain discharge. The charged particles generated by this weak discharge accumulate on sustain electrode SUi and scan electrode SCi as wall charge so as to reduce the voltage difference between sustain electrode SUi and scan electrode SCi. This reduces the wall voltage on scan electrode SCi and the wall voltage on sustain electrode SUi while the positive wall voltage on data electrode Dk is left. That is, unnecessary wall charge in the discharge cells is erased.

After the voltage applied to scan electrode SC1-scan electrode SCn has reached voltage Vers, the voltage applied to scan electrode SC1-scan electrode SCn is lowered to voltage 0 (V). Thus, the sustain operation in the sustain period of subfield SF1 is completed.

With the above operation, subfield SF1 is completed.

In the initializing period of subfield SF2 where a selective initializing operation is performed, driving voltage waveforms where the first half of the initializing period of subfield SF1 is omitted are applied to the respective electrodes for the selective initializing operation.

In the initializing period of subfield SF2, voltage Ve1 is applied to sustain electrode SU1-sustain electrode SUn and voltage 0 (V) is applied to data electrode D1-data electrode Dm. A ramp waveform voltage (hereinafter, “ramp voltage L4”) gently falling from a voltage (e.g. voltage 0 (V)) lower than the discharge start voltage toward negative voltage Vi4 with a gradient equal to that of ramp voltage L2 (approximately −2.5 V/μsec, for example) is applied to scan electrode SC1-scan electrode SCn. Voltage Vi4 is set to a voltage exceeding the discharge start voltage with respect to sustain electrode SU1-sustain electrode SUn.

While this ramp voltage L4 is applied to scan electrode SC1-scan electrode SCn, a weak initializing discharge is caused in the discharge cells having undergone a sustain discharge in the sustain period of the immediately preceding subfield (subfield SF1 in FIG. 4). This initializing discharge reduces the wall voltage on scan electrode SCi and sustain electrode SUi. Since sufficient positive wall voltage is accumulated on data electrode Dk by the sustain discharge caused in the sustain period of the immediately preceding subfield, the excess part of this wall voltage is discharged and the wall voltage on data electrode Dk is adjusted to a value appropriate for the address operation.

In contrast, in the discharge cells having undergone no sustain discharge in the sustain period of the immediately preceding subfield (subfield SF1), no initializing discharge occurs, and the wall voltage having been generated before is maintained.

In this manner, the initializing operation in subfield SF2 is a selective initializing operation for causing an initializing discharge selectively in the discharge cells having undergone an address operation in the address period of the immediately preceding subfield, i.e. in the discharge cells having undergone a sustain discharge in the sustain period of the immediately preceding subfield.

As described above, an initializing operation in the initializing period of subfield SF2, i.e. a selective initializing operation, is completed.

In the address period of subfield SF2, an address operation is performed so as to apply the driving voltage waveforms similar to those in the address period of subfield SF1 to the respective electrodes and accumulate the wall voltage on the respective electrodes of the discharge cells to be lit.

In the subsequent sustain period, similarly to the sustain period of subfield SF1, sustain pulses corresponding in number to the luminance weight are alternately applied to scan electrode SC1-scan electrode SCn and sustain electrode SU1-sustain electrode SUn, and a sustain discharge is caused in the discharge cells having undergone an address discharge in the address period.

In the initializing period and the address period of subfield SF3 and each subfield thereafter, the driving voltage waveforms similar to those in the initializing period and the address period of subfield SF2 are applied to the respective electrodes. In the sustain periods of subfield SF3 and each subfield thereafter, driving voltage waveforms similar to those in subfield SF2 except for the number of sustain pulses generated in the sustain period are applied to the respective electrodes.

The above description has outlined the driving voltage waveforms to be applied to the respective electrodes of panel 10 in this exemplary embodiment.

The values of voltages to be applied to the respective electrodes in this exemplary embodiment are set as follows: voltage Vi1=145 (V); voltage Vi2=335 (V); voltage Vi3=190 (V); voltage Vi4=−160 (V); voltage Va=−180 (V); voltage Vs=190 (V); voltage Vers=190 (V); voltage Ve1=125 (V); voltage Ve2=130 (V); and voltage Vd=60 (V). Voltage Vc can be generated by superimposing positive voltage Vscn=145 (V) on negative voltage Va=−180 (V) (Vc=Va+Vscn), where Vc=−35 (V).

The specific numerical values, such as above voltage values and the gradients of the ramp waveform voltages, are only examples. In the present invention, the respective voltage values or gradients are not limited to the above numerical values. Preferably, the respective voltage values, gradients, or the like are set appropriately for the discharge characteristic of the panel and the specifications of the plasma display apparatus, for example.

Next, a description is provided for the driving voltage waveforms to be applied to the respective electrodes of panel 10 when a 3D image signal is input into plasma display apparatus 40, together with an opening/closing operation of the shutters of pair of shutter glasses 50.

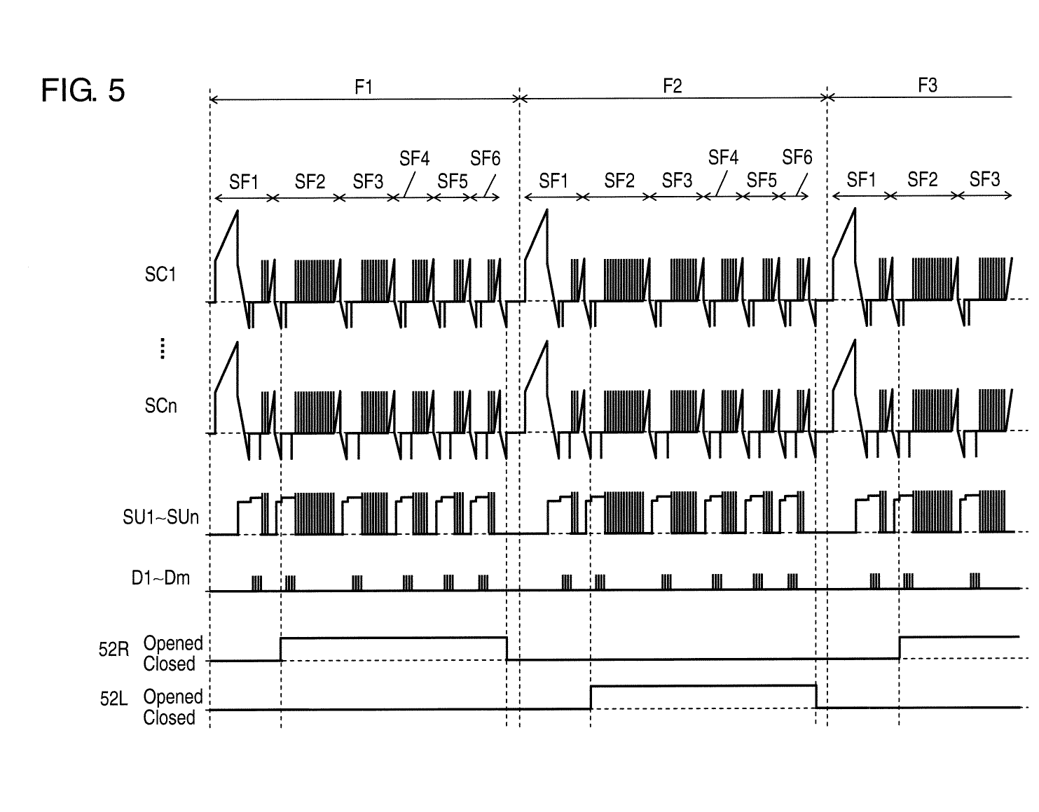

FIG. 5 is a waveform chart schematically showing driving voltage waveforms applied to the respective electrodes of panel 10 for use in plasma display apparatus 40 and an opening/closing operation of pair of shutter glasses 50 in accordance with the exemplary embodiment of the present invention.

FIG. 5 shows driving voltage waveforms applied to scan electrode SC1 for undergoing an address operation first in the address periods, scan electrode SCn for undergoing an address operation last in the address periods, sustain electrode SU1-sustain electrode SUn, and data electrode D1-data electrode Dm. FIG. 5 also shows an opening/closing operation of right eye shutter 52R and left eye shutter 52L.

A 3D image signal is an image signal for stereoscopic view where an image signal for the right eye and an image signal for the left eye are alternately repeated in each field. Upon receipt of a 3D image signal, plasma display apparatus 40 alternately displays an image for the right eye and an image for the left eye by alternately repeating a field for the right eye for display of the image signal for the right eye, and a field for the left eye for display of the image signal for the left eye. For example, among three fields (field F1-field F3) shown in FIG. 5, field F1 and field F3 are fields for the right eye, where an image signal for the right eye is displayed on panel 10. Field F2 is a field for the left eye, where an image signal for the left eye is displayed on panel 10. Thus, plasma display apparatus 40 displays a 3D image for stereoscopic view formed of an image for the right eye and an image for the left eye on panel 10.

The user who views a 3D image displayed on panel 10 through pair of shutter glasses 50 perceives images displayed in two fields (an image for the right eye and an image for the left eye) as one 3D image. Thus, the user perceives the number of 3D images displayed on panel 10 per unit time (e.g. per second) as a half the field frequency (the number of fields occurring per second).

For instance, when the field frequency (the number of fields generated per second) of 3D images displayed on the panel is 60 Hz, 30 images for the right eye and 30 images for the left eye are displayed on panel 10 per second. Thus, the user perceives thirty 3D images per second. Therefore, in order to display sixty 3D images per second, the field frequency needs to be set to 120 Hz, which is twice of 60 Hz. Then, in this exemplary embodiment, the field frequency is set to twice (e.g. 120 Hz) the general field frequency so that the user can perceive a smooth 3D moving image, and flickering (flickers) likely to occur in display of images having a low field frequency is reduced.

The user perceives 3D images displayed on panel 10 through pair of shutter glasses 50 where right eye shutter 52R and left eye shutter 52L are opened and closed independently in synchronization with the field for the right eye and the field for the left eye, respectively. With this operation, the user can view an image for the right eye only with the right eye and an image for the left eye only with the left eye, thereby stereoscopically viewing the 3D image displayed on panel 10.

In the field for the right eye and the field for the left eye, only the signals of the images to be displayed are different. The subfield structure, e.g. the number of subfields forming one field, the luminance weights of the respective subfields, and the arrangement of the subfields, is identical with each other. Hereinafter, when a field “for the right eye” and a field “for the left eye” do not need to be discriminated, each of the field for the right eye and the field for the left eye is simply referred to as a field, and each of an image signal for the right eye and an image signal for the left eye is also simply referred to as an image signal. The structure of the fields is also referred to as the subfield structure.

As described above, in plasma display apparatus 40 of this exemplary embodiment, in order to reduce flickers (a phenomenon such that the display image looks flickering) when panel 10 is driven by a 3D image signal, the field frequency is set to twice (e.g. 120 Hz) of that when a 2D image signal is displayed on panel 10. For this reason, one field period (e.g. 8.3 msec) when a 3D image signal is displayed on panel 10 is a half of one field period (e.g. 16.7 msec) when a 2D image signal is displayed on panel 10.

Then, in plasma display apparatus 40 of this exemplary embodiment, when panel 10 is driven by a 3D image signal, the number of subfields forming one field is smaller than that when panel 10 is driven by a 2D image signal. In this exemplary embodiment, a description is provided for a structure where each of the field for the right eye and the field for the left eye is formed of six subfields (subfield SF1, subfield SF2, subfield SF3, subfield SF4, subfield SF5, and subfield SF6). In a manner similar to that when panel 10 is driven by a 2D image signal, each subfield has an initializing period, an address period, and a sustain period. In the initializing period of subfield SF1, an all-cell initializing operation is performed. In the initializing periods of the other subfields, a selective initializing operation is performed.

Subfield SF1-subfield SF6 have respective luminance weights of 1, 16, 8, 4, 2, and 1. In this manner, in this exemplary embodiment, the luminance weights are set for the respective subfields such that subfield SF1 occurring first in one field is a subfield having the smallest luminance weight, subfield SF2 occurring second is a subfield having the largest luminance weight, and the luminance weights in the subfields thereafter sequentially decease.

In this exemplary embodiment, this structure of the respective fields can reduce the leak of the light emission from an image for the right eye into an image for the left eye, and the leak of the light emission from an image for the left eye into an image for the right eye (hereinafter referred to as “crosstalk”), and stabilize the address operation. This will be detailed later.

The driving voltage waveforms to be applied to the respective electrodes in each subfield is identical with those when a 2D image signal is displayed on panel 10 except for the numbers of sustain pulses generated in the sustain periods and thus the description is omitted.

In this manner, in this exemplary embodiment, when a 3D image signal is displayed on panel 10, the respective subfields forming one field have luminance weights decreasing in the generation order of the subfields except for subfield SF1, so that the luminance weights of the respective subfields are smaller in the subfields generated temporally later. This is for the following reasons.

Phosphor layers 35 for use in panel 10 have afterglow characteristics depending on the materials making up the phosphors. This afterglow is a phenomenon such that the phosphor maintains light emission even after the completion of discharge. The intensity of the afterglow is proportional to the luminance when the phosphor emits light. When the phosphor emits light at higher luminance, the afterglow is more intense. The afterglow attenuates with a time constant corresponding to the characteristic of the phosphor. With a lapse of time, the luminance gradually attenuates. For example, there is a phosphor material that has a characteristic of persistence of afterglow for several milliseconds after the completion of a sustain discharge. When the phosphor emits light at a higher luminance, the time taken for sufficient attenuation is longer.

The light emission in a subfield having a larger luminance weight causes a luminance higher than that of the light emission in a subfield having a smaller luminance weight. Therefore, the afterglow caused by the light emission in a subfield having a larger luminance weight has a higher luminance and takes a longer attenuation time than the afterglow caused by the light emission in a subfield having a smaller luminance weight.

For this reason, if the last subfield of one field is a subfield having a large luminance weight, the afterglow leaking into the succeeding field is larger than that when the last subfield is a subfield having a small luminance weight.

In plasma display apparatus 40 for displaying a 3D image on panel 10 by alternately generating a field for the right eye and a field for the left eye, when the afterglow generated in one field leaks into the succeeding field, the afterglow is perceived by the user as unnecessary light emission unrelated to the image signal. In this exemplary embodiment, this phenomenon is referred to as “crosstalk”.

Therefore, as the afterglow leaking from one field into the next field increases, the crosstalk increases. This inhibits the stereoscopic view of a 3D image and degrades the image display quality in plasma display apparatus 40. This image display quality is the image display quality for the user who views a 3D image through pair of shutter glasses 50.

In order to reduce the afterglow leaking from one field into the next field and reduce the crosstalk, a subfield having a large luminance weight is generated at an earlier time of one field so as to allow the strong afterglow to settle in that field. Further, the last subfield of the one field is set to a subfield having a small luminance weight such that the leak of the afterglow into the next field is minimized.

That is, the following method is preferable in inhibiting the crosstalk in display of a 3D image signal on panel 10. A subfield having a relatively large luminance weight is generated at the beginning of the field, thereafter, the luminance weight is decreased in the generation order of the subfields, and the last subfield of the field is a subfield having a relatively small luminance weight. In this manner, the leak of the afterglow into the next field is minimized.

This is the reason why the luminance weights of the subfields except subfield SF1 are set smaller in the subfields occurring temporally later in the plurality of subfields forming one field. In this exemplary embodiment, the number of subfields forming one field or the luminance weights of the respective subfields is not limited to the above values. For example, the following structure may be used. Subfield SF1 is a subfield having the smallest luminance weight, subfield SF2 is a subfield having the largest luminance weight, the luminance weights sequentially decrease in subfield SF3 and those thereafter, and the last subfield in the field is a subfield having the second smallest luminance weight.

On the other hand, in this exemplary embodiment, subfield SF1 is set to an all-cell initializing subfield. Therefore, in the initializing period of subfield SF1, an initializing discharge can be caused in all the discharge cells so as to generate wall charge and priming particles necessary for the address operation.

However, wall charge and priming particles generated by the all-cell initializing operation in the initializing period of subfield SF1 are gradually lost with a lapse of time. Insufficient wall charge and priming particles destabilize the address operation.

In the discharge cells that have undergone no address operation in the intermediate subfields after having undergone an initializing discharge in the all-cell initializing operation in subfield SF1 and are to undergo an address operation only in the last subfield, wall charge and priming particles are gradually lost with a lapse of time, which can destabilize the address operation in the last subfield.

Therefore, in a 2D driving where one field period is longer than that in a 3D driving, the address operation tends to be unstable in the discharge cells for undergoing address operation only in the last subfield of one field.

However, wall charge and priming particles are replenished by the occurrence of sustain discharge. For example, in the discharge cells having undergone a sustain discharge in the sustain period of subfield SF1, the sustain discharge replenishes the wall charge and priming particles.

Further, it is verified that a sustain discharge occurs more frequently in a subfield having a relatively small luminance weight than in a subfield having a relatively large luminance weight, in generally viewed moving images.

For this reason, in a 2D driving where the one field period is longer than that in a 3D driving, the subfield having a relatively small luminance weight where a sustain discharge more frequently occurs is generated at the beginning of the field, and the luminance weights are increased in the subfields occurring temporally later in the field. In the 2D driving, this structure can increase the probability of occurrence of a sustain discharge at the beginning of one field, increases the number discharge cells in which the wall charge and priming particles are replenished by a sustain discharge at the beginning of the one field, and stabilize the address operation in the last subfield of the one field.

On the other hand, in the 3D driving, as described above, the following structure is preferable in reducing crosstalk. The luminance weights of the respective subfields are set so as to be smaller in the subfields occurring temporally later in one field. However, if the subfield having the largest luminance weight is set as a first subfield, the number of discharge cells where the wall charge and priming particles are replenished by the sustain discharge decreases in the first subfield of the field. Further, in the subfield having a large luminance weight, the sustain period is longer. Thus, the address operation can be destabilized in the succeeding subfields.

In order to reduce the crosstalk and stabilize the address operation in the last subfield of one field at the same time, the following subfield structure is preferable. The luminance weights of the respective subfields are set so as to be smaller in subfields occurring temporally later in the one field, a subfield having a larger luminance weight is generated at an earlier time of the one field, and a sustain discharge is caused at the beginning of the field so as to replenish wall charge and priming particles.

Then, in this exemplary embodiment, subfield SF1 is set to an auxiliary subfield for stabilizing the address operation in the succeeding subfields. Specifically, subfield SF1 is a subfield where a sustain discharge is caused in the sustain period in all the discharge cells in the image display area. Therefore, the subfield structure is such that subfield SF1 is a subfield that does not contribute to display of gradations, subfield SF2 is a subfield having the largest luminance weight, and subfield SF3 and those thereafter have luminance weights sequentially decreasing. This structure reduces the crosstalk by reducing the leak of the afterglow into the next field. The sustain discharge caused in the sustain period of subfield SF1 replenishes wall charge and priming particles in the discharge cells, thereby stabilizing the address operation in the last subfield.

In this exemplary embodiment, in subfield SF1, light emission caused by a sustain discharge always occurs in all the discharge cells in the image display area. If this light emission increases the luminance of black level, the contrast ratio in the display image is impaired. Then, in this exemplary embodiment, this light emission is blocked with right eye shutter 52R and left eye shutter 52L by the control of pair of shutter glasses 50, which will be described next. This operation inhibits the light emission into the eyes of the user and prevents an increase in the luminance of black level.

Next, a description is provided for the control of pair of shutter glasses 50. The opening/closing operation of right eye shutter 52R and left eye shutter 52L of pair of shutter glasses 50 is controlled based on ON/OFF of shutter opening/closing timing signals (a timing signal for opening/closing the right eye shutter and a timing signal for opening/closing the left eye shutter) that are output from timing signal output part 46 and received by pair of shutter glasses 50.

Control signal generation circuit 45 generates the shutter opening/closing timing signals such that the timing signal for opening/closing the right eye shutter and the timing signal for opening/closing the left eye shutter are both set to OFF in subfield SF1, i.e. from the all-cell initializing period to the sustain period of subfield SF1, of a field for the right eye and a field for the left eye, when the driver circuit of plasma display apparatus 40 performs 3D driving.

That is, in fields for the right eye (field F1 and field F3 in the example of FIG. 5), the control signal generation circuit generates a shutter opening/closing timing signal (a timing signal for opening/closing the right eye shutter) such that right eye shutter 52R is closed until the completion of the sustain period of subfield SF1, i.e. the first subfield, opens before the start of the sustain period of subfield SF2, and closes after the generation of all the sustain pulses in the sustain period of the last subfield (e.g. subfield SF6) has been completed.

In a field for the left eye (field F2 in the example of FIG. 5), the control signal generation circuit generates a shutter opening/closing timing signal (a timing signal for opening/closing the left eye shutter) such that left eye shutter 52L is closed until the completion of the sustain period of subfield SF1, opens before the start of the sustain period of subfield SF2, and closes after the generation of all the sustain pulses in the sustain period of the last subfield (e.g. subfield SF6) has been completed. The similar operations are repeated in each field.

Therefore, in this exemplary embodiment, both of right eye shutter 52R and left eye shutter 52L of pair of shutter glasses 50 are in a closed state in a period from the initializing period (all-cell initializing period) to the sustain period of the all-cell initializing subfield (subfield SF1) in any of the fields for the right eye and the fields for the left eye.

Thus, the light emission generated by the all-cell initializing operation and the sustain operation in subfield SF1 is blocked by right eye shutter 52R and left eye shutter 52L and does not enter the eyes of the user. In this state, the user who views a 3D image through pair of shutter glasses 50 does not perceive the light emission caused by the all-cell initializing operation and the sustain operation in subfield SF1. This phenomenon reduces the luminance of black level by the luminance caused by that light emission.

With this operation, in this exemplary embodiment, subfield SF1 serves as an auxiliary subfield. That is, subfield SF1 is a subfield where the sustain discharge for replenishing wall charge and priming particles is always generated in all the discharge cells in the image display area, but the luminance of black level to the user who views a 3D image through pair of shutter glasses 50 is not affected.

The period during which right eye shutter 52R and left eye shutter 52L are both in a closed state is set to a period from the initializing period (all-cell initializing period) to the sustain period of the all-cell initializing subfield (subfield SF1). Thus, the period during which right eye shutter 52R and left eye shutter 52L are both in a closed state is relatively long. In that period, more afterglow can be attenuated. This operation can not only block the light emission caused by the sustain discharge of subfield SF1 to the user who views a 3D image through pair of shutter glasses 50, but also inhibits the user from perceiving the afterglow in the previous field. Thus, the advantage of reducing the crosstalk can be enhanced.

In this exemplary embodiment, the above operation can reduce the crosstalk while stabilizing the address operation in the last subfield when a 3D image is displayed on panel 10.

The timing at which a shutter opening/closing timing signal is switched from ON to OFF or OFF to ON is preset in accordance with the characteristics of pair of shutter glasses 50 and the field structure. Control signal generation circuit 45 generates the shutter opening/closing timing signal in response to the preset timing.

In this exemplary embodiment, the above state where “shutters are closed” is not limited to the state where right eye shutter 52R and left eye shutter 52L are completely closed. The above state where “shutters are opened” is not limited to the state where right eye shutter 52R and left eye shutter 52L are completely opened.

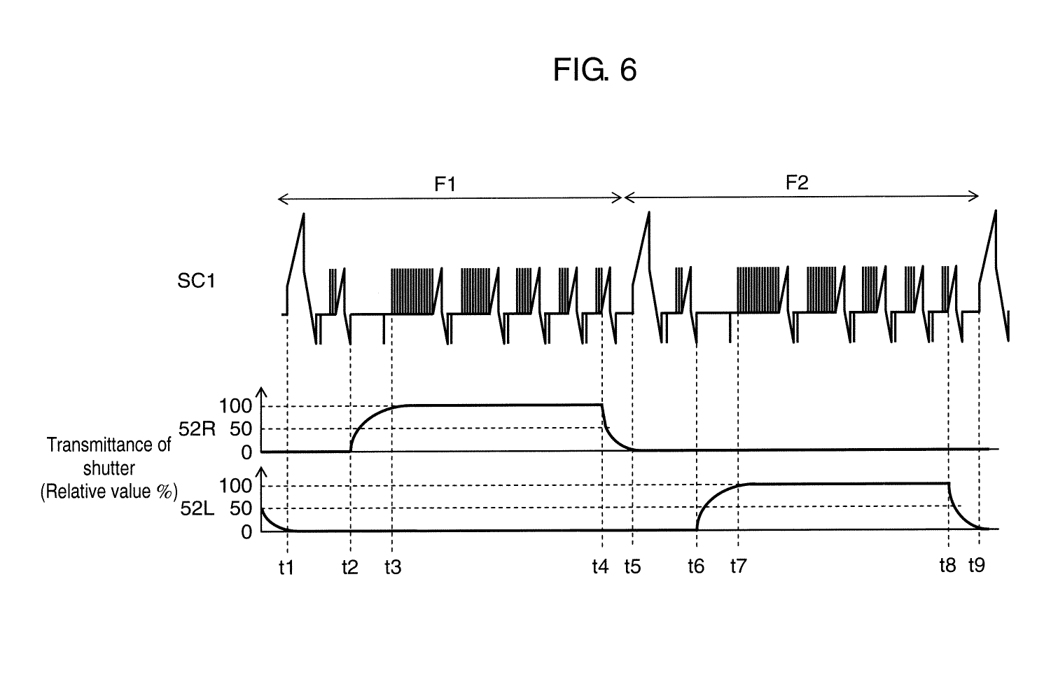

FIG. 6 is a diagram schematically showing a subfield structure in display of a 3D image in plasma display apparatus 40, and opening/closing states of right eye shutter 52R and left eye shutter 52L in accordance with the exemplary embodiment of the present invention. FIG. 6 shows the driving voltage waveforms applied to scan electrode SC1 and the opening/closing states of right eye shutter 52R and left eye shutter 52L of pair of shutter glasses 50. FIG. 6 also shows two fields (field for the right eye F1 and field for the left eye F2).

A diagram of the opening/closing states of pair of shutter glasses 50 in FIG. 6 shows the opening/closing states of right eye shutter 52R and left eye shutter 52L with a transmittance. The transmittance is a percentage of transmittance of visible light shown in the following manner. The state where a shutter is completely opened is set as a transmittance of 100% (a maximum transmittance) and the state where a shutter is completely closed is set as a transmittance of 0% (a minimum transmittance). In the diagram showing opening/closing of the shutters of FIG. 6, the vertical axis shows a transmittance of the shutters in a relative manner. The horizontal axis shows time.

In this exemplary embodiment, when the shutters of pair of shutter glasses 50 are closed, preferably, the shutter closing timing is set in the following manner. At time t1 immediately before the start of the all-cell initializing operation of field F1, left eye shutter 52L having been opened until then completely closes, and both of left eye shutter 52L and right eye shutter 52R have a transmittance of 0%. Preferably, the shutter closing timing is set also in the following manner. At time t5 immediately before the start of the all-cell initializing operation of field F2, right eye shutter 52R having been opened until then completely closes, and both of left eye shutter 52L and right eye shutter 52R have a transmittance of 0%.

When the shutters of pair of shutter glasses 50 are opened, preferably, the shutter opening timing is set in the following manner. At time t3 immediately before the start of the sustain period of subfield SF2 of field F1, right eye shutter 52R completely opens so as to have a transmittance of 100%. At time t7 immediately before the start of the sustain period of subfield SF2 of field F2, left eye shutter 52L completely opens so as to have a transmittance of 100%.

However, in the present invention, the opening/closing operation of the shutters is not limited to this structure.

In pair of shutter glasses 50, the time corresponding to the characteristics of the materials (e.g. liquid crystal) making up each shutter is taken after the shutter starts to close and before it completely closes, or after the shutter starts to open and before it completely opens. For example, in a pair of shutter glasses formed of liquid crystal, each shutter takes approximately 0.5 msec to start to close and completely close, and takes approximately 2 msec to start to open and completely open, in some cases.

Then, in this exemplary embodiment, when a shutter is closed, the shutter closing timing is set such that the transmittance of the shutter becomes equal to or lower than 30%, preferably 10%, immediately before the start of the all-cell initializing operation. For example, in the example shown in FIG. 6, the shutter closing timing is set such that the transmittance of left eye shutter 52L becomes equal to or lower than 30%, preferably 10%, at time t1 (at time t9, similarly) immediately before the start of the all-cell initializing operation in subfield SF1, i.e. the first subfield of field for the right eye F1. The shutter closing timing is set such that the transmittance of right eye shutter 52R becomes equal to or lower than 30%, preferably 10%, at time t5 immediately before the start of the all-cell initializing operation in subfield SF1 i.e. the first subfield of field for the left eye F2.

At this time, it is preferable to set the time after the generation of the sustain pulses in the sustain period of the last subfield has completed and before the start of the all-cell initializing operation in the first subfield in consideration of the time taken after the shutter starts to close and before it completely closes. In the example shown in FIG. 6, the interval between time t4 and time t5 is set in the following manner. At least when right eye shutter 52R starts to close at time t4 immediately after the generation of the sustain pulses has been completed in subfield SF6, i.e. the last subfield in field for the right eye F1, the transmittance of right eye shutter 52R becomes equal to or lower than 30%, preferably 10%, at time t5.

Similarly, the interval between time t8 and time t9 is set in the following manner. At least when left eye shutter 52L starts to close at time t8 immediately after the generation of the sustain pulses has been completed in subfield SF6, i.e. the last subfield in field for the left eye F2, the transmittance of left eye shutter 52L becomes equal to or lower than 30%, preferably 10%, at time t9, immediately before the start of the all-cell initializing operation in subfield SF1 in the subsequent field for the right eye.

When each shutter is opened, the shutter opening timing is set such that the transmittance of the shutter becomes equal to or higher than 70%, preferably 90%, immediately before the start of the sustain period of subfield SF2. In the example shown in FIG. 6, the shutter opening timing is set such that the transmittance of right eye shutter 52R becomes equal to or higher than 70%, preferably 90%, at time t3 immediately before the generation of the sustain pulses in subfield SF2 in field for the right eye F1. The shutter opening timing is set such that the transmittance of left eye shutter 52L becomes equal to or higher than 70%, preferably 90%, at time t7 immediately before the generation of the sustain pulses in subfield SF2 in field for the left eye F2.

At this time, it is preferable to set the time after the completion of subfield SF1 and before the start of the sustain pulses in subfield SF2 in consideration of the time taken after the shutter starts to open and before it completely opens.

In the example shown in FIG. 6, the interval between time t2 and time t3 is set in the following manner. At least when right eye shutter 52R starts to open at time t2 immediately after the completion of subfield SF1 in field for the right eye F1, the transmittance of right eye shutter 52R becomes equal to or higher than 70%, preferably 90%, at time t3.

Similarly, the interval between time t6 and time t7 is set in the following manner. At least when left eye shutter 52L starts to open at time t6 immediately after the completion of subfield SF1 in field for the left, eye F2, the transmittance of left eye shutter 52L becomes equal to or higher than 70%, preferably 90%, at time t7.

In this manner, in this exemplary embodiment, the opening/closing operation of the shutter is controlled in consideration of the time taken after the shutter starts to close and before it completely closes, and the time taken after the shutter starts to open before it completely opens.

As shown above, in this exemplary embodiment, when panel 10 is driven based on a 3D image signal, the first subfield of one field is set as an all-cell initializing subfield where an all-cell initializing operation is performed. Further, the first subfield of the one field is set as an auxiliary subfield where a sustain discharge is always caused in all the discharge cells in the image display area of panel 10 in the sustain period. The second subfield is set as a subfield having the largest luminance weight. The third subfield and those thereafter have luminance weights sequentially decreasing.

When panel 10 is driven based on a 3D image signal, this subfield structure can suppress crosstalk by reducing the afterglow leaking into the next field, and stabilize the address operation in the last subfield of one field.

Then, pair of shutter glasses 50 is controlled such that both right eye shutter 52R and left eye shutter 52L are in a closed state from the all-cell initializing period to the sustain period in subfields SF1 of fields for the right eye and fields for the left eye. This control method enables the user who views a 3D image displayed on panel 10 through pair of shutter glasses 50 not to perceive the light emission caused by the all-cell initializing operation and the sustain operation in subfield SF1. This control method can provide the excellent luminance of black level by reducing the luminance of the light emission caused by this discharge, and provide the user a 3D image of enhanced contrast.

In this exemplary embodiment, subfield SF1 is a subfield intended for replenishing wall charge and priming particles in the discharge cells. Thus, as the number of sustain pulses generated in the sustain period, a number that can achieve the purpose is sufficient, and an unnecessarily large number of sustain pulses do not need to be generated. According to the experiments conducted by the inventor, application of one sustain pulse to each of scan electrodes 22 and sustain electrodes 23 can advantageously stabilize the address operation in the last subfield. Then, in this exemplary embodiment, the luminance weight of subfield SF1 is set to “1”. However, it is preferable to set the number of sustain pulses generated in the sustain period of subfield SF1 optimally for the characteristics of the panel and the specifications of the plasma display apparatus.

In the sustain period of each subfield, a number of sustain pulses equal in number to the luminance weight multiplied by a predetermined luminance magnification are generated. However, in the sustain period of subfield SF1, a predetermined number of sustain pulses (e.g. one sustain pulse to each of scan electrodes 22 and sustain electrodes 23) may be generated regardless of the luminance magnification.

In the structure described in this exemplary embodiment, the driving voltage waveforms applied to scan electrodes 22 in the all-cell initializing operation in 3D driving are identical in waveform shape with the driving voltage waveforms applied to scan electrodes 22 in the all-cell initializing operation in 2D driving. However, the present invention is not limited to this structure and the all-cell initializing operation in 3D driving may be performed in the following manner, for example. The gradient of the up-ramp waveform voltage in the all-cell initializing operation in 3D driving may be steeper than the gradient of the up-ramp waveform voltage in the all-cell initializing operation in 2D driving. Alternatively, the gradient of the down-ramp waveform voltage in the all-cell initializing operation in 3D driving may be steeper than the gradient of the down-ramp waveform voltage in the all-cell initializing operation in 2D driving.

In the structure of this exemplary embodiment, voltage Vi2 in 3D driving and voltage Vi2 in 2D driving have an equal value. However, these voltage values may be different from each other.

In this exemplary embodiment, an address discharge is caused in all the discharge cells in the image display area in the address period of subfield SF1, in 3D driving. Thereby, in the sustain period, a sustain discharge is caused in all the discharge cells. However, the present invention is not limited to this structure. For instance, if a strong discharge is caused by ramp voltage L1 generated in the initializing period with a steep gradient and generates wall charge and priming particles that eliminate the need for address operation, a sustain discharge can be caused without address operation. Therefore, the following structure can be used. That is, the address period is omitted by causing an initializing discharge strong enough to eliminate the need for address operation in all the discharge cells in the initializing period of subfield SF1 in 3D driving. In this case, the time for the address period can be shortened in subfield SF1 in 3D driving.

The driving voltage waveforms of FIG. 4, FIG. 5, and FIG. 6 only show examples in the exemplary embodiment of the present invention. The present invention is not limited to these driving voltage waveforms. The circuit configuration of FIG. 3 only shows an example in the exemplary embodiment of the present invention. The present invention is not limited to such circuit configuration.

FIG. 5 shows an example where a down-ramp waveform voltage is generated and applied to scan electrode SC1-scan electrode SCn in the period after the completion of subfield SF6 and before the start of subfield SF1. However, these voltages do not need to be generated. For example, in the period after the completion of subfield SF6 and before the start of subfield SF1, scan electrode SC1-scan electrode SCn, sustain electrode SU1-sustain electrode SUn, and data electrode D1-data electrode Dm may be kept at 0 (V).

In the structure described in this exemplary embodiment of the present invention, one field is formed of eight subfields in 2D driving, and one field is formed of six subfields in 3D driving. However, in the present invention, the number of subfields forming one field is not limited the above values. For example, increasing the number of subfields can increase the number of gradations displayable on panel 10.

In the example described in this exemplary embodiment of the present invention, the luminance weights of the subfields are powers of “2”. For example, in 2D driving, the luminance weights of respective subfield SF1-subfield SF8 are 1, 2, 4, 8, 16, 32, 64, and 128. In 3D driving, the luminance weights of respective subfield SF1-subfield SF6 are 1, 16, 8, 4, 2, and 1. However, the luminance weights of the respective subfields are not limited to the above numerical values. In 3D driving, setting the luminance weights of respective subfield SF1-subfield SF6 to 1, 12, 7, 3, 2, and 1, for example, gives redundancy to the combination of the subfields determining gradations and allows the coding for suppressing the generation of the moving image false contour. The number of subfields forming one field, the luminance weights of the respective subfields, or the like is set appropriately for the characteristics of panel 10 and the specifications of plasma display apparatus 40.

Each circuit block shown in the exemplary embodiment of the present invention may be formed as an electric circuit that performs each operation shown in the exemplary embodiment, or formed of a microcomputer programmed so as to perform the similar operations, for example.

In the example described in this exemplary embodiment, one pixel is formed of discharge cells of R, G, and B three colors. Also a panel that includes pixels, each formed of discharge cells of four or more colors, can use the structure shown in this exemplary embodiment and provide the same advantages.

The specific numerical values shown in the exemplary embodiment of the present invention are set based on the characteristics of panel 10 that has a 50-inch screen and 1024 display electrode pairs 24, and simply show examples in the exemplary embodiment. The present invention is not limited to these numerical values. Preferably, each numerical value is set optimally for the characteristics of the panel, the specifications of the plasma display apparatus, or the like. Variations are allowed for each numerical value within the range in which the above advantages can be obtained. Further, the number of subfields forming one field, the luminance weights of the respective subfields, or the like is not limited to the values shown in the exemplary embodiment of the present invention. The subfield structure may be switched based on image signals, for example.

### INDUSTRIAL APPLICABILITY

The present invention can stabilize address operation and provide a 3D image of excellent contrast with reduced crosstalk, to the user who views the display image through a pair of shutter glasses in a plasma display apparatus usable as a 3D image display apparatus. Thus, the present invention is useful as a plasma display apparatus, a plasma display system, and a control method for a pair of shutter glasses for the plasma display apparatus.

### REFERENCE MARKS IN THE DRAWINGS

10 Panel
21 Front substrate
22 Scan electrode
23 Sustain electrode
24 Display electrode pair
25, 33 Dielectric layer
26 Protective layer
31 Rear substrate
32 Data electrode
34 Barrier rib
35 Phosphor layer
40 Plasma display apparatus
41 Image signal processing circuit
42 Data electrode driver circuit
43 Scan electrode driver circuit
44 Sustain electrode driver circuit
45 Control signal generation circuit
46 Timing signal output part
50 Pair of shutter glasses
52R Right eye shutter
52L Left eye shutter
L2, L2, L4 Ramp voltage
L3 Erasing ramp voltage

1. A plasma display apparatus comprising:
a plasma display panel having a plurality of discharge cells, each of the discharge cells having a display electrode pair, the display electrode pair including a scan electrode and a sustain electrode;
a driver circuit for displaying an image on the plasma display panel by alternately repeating a field for a right eye for display of an image signal for the right eye, and a field for a left eye for display of an image signal for the left eye based on the image signals including the image signal for the right eye and the image signal for the left eye, in a manner such that a plurality of subfields, each having an initializing period, an address period, and a sustain period, forms one field, and a subfield where an up-ramp waveform voltage is applied to the scan electrodes in the initializing period and a sustain discharge is caused in all the discharge cells in the sustain period is set as a first subfield of the one field; and
a control signal generation circuit for generating shutter opening/closing timing signals that include a timing signal for the right eye and a timing signal for the left eye, the timing signal for the right eye being set to ON when the field for the right eye is displayed on the plasma display panel and to OFF when the field for the left eye is displayed, the timing signal for the left eye being set to ON when the field for the left eye is displayed and to OFF when the field for the right eye is displayed,
wherein, in a period of the first subfield, the control signal generation circuit generates the shutter opening/closing timing signals that set both of the timing signal for the right eye and the timing signal for the left eye to OFF.

2. The plasma display apparatus of claim 1, wherein in the sustain periods of the subfields except the first subfield, the driver circuit generates sustain pulses equal in number to a luminance weight multiplied by a luminance magnification, and in the sustain period of the first subfield, a fixed number of sustain pulses are generated regardless of the luminance magnification.

3. The plasma display apparatus of claim 1, wherein the driver circuit performs no address operation in the address period of the first subfield.

4. A plasma display system comprising:
a plasma display apparatus including:
a plasma display panel having a plurality of discharge cells, each of the discharge cells having a display electrode pair, the display electrode pair including a scan electrode and a sustain electrode;
a driver circuit for displaying an image on the plasma display panel by alternately repeating a field for a right eye for display of an image signal for the right eye, and a field for a left eye for display of an image signal for the left eye based on the image signals including the image signal for the right eye and the image signal for the left eye, in a manner such that a plurality of subfields, each having an initializing period, an address period, and a sustain period, forms one field, and a subfield where an up-ramp waveform voltage is applied to the scan electrodes in the initializing period and a sustain discharge is caused in all the discharge cells in the sustain period is set as a first subfield of the one field; and
a control signal generation circuit for generating shutter opening/closing timing signals that include a timing signal for the right eye and a timing signal for the left eye, the timing signal for the right eye being set to ON when the field for the right eye is displayed on the plasma display panel and to OFF when the field for the left eye is displayed, the timing signal for the left eye being set to ON when the field for the left eye is displayed and to OFF when the field for the right eye is displayed; and
a pair of shutter glasses, the shutter glasses including a right eye shutter and a left eye shutter that can be opened and closed independently, opening/closing of the shutters being controlled by the shutter opening/closing timing signals generated in the control signal generation circuit,
wherein, in a period of the first subfield, both of the right eye shutter and the left eye shutter are in a closed state.

5. A control method for a pair of shutter glasses for a plasma display apparatus,
the pair of shutter glasses being used to view an image displayed on the plasma display apparatus, and having a right eye shutter and a left eye shutter that can be opened and closed independently,
the plasma display apparatus including:
a plasma display panel having a plurality of discharge cells, each of the discharge cells having a display electrode pair, the display electrode pair including a scan electrode and a sustain electrode;
a driver circuit for displaying an image on the plasma display panel by alternately repeating a field for a right eye for display of an image signal for the right eye, and a field for a left eye for display of an image signal for the left eye based on the image signals including the image signal for the right eye and the image signal for the left eye, in a manner such that a plurality of subfields, each having an initializing period, an address period, and a sustain period, forms one field, and a subfield where an up-ramp waveform voltage is applied to the scan electrodes in the initializing period and a sustain discharge is caused in all the discharge cells in the sustain period is set as a first subfield of the one field; and
a control signal generation circuit for generating shutter opening/closing timing signals that include a timing signal for the right eye and a timing signal for the left eye, the timing signal for the right eye being set to ON when the field for the right eye is displayed on the plasma display panel and to OFF when the field for the left eye is displayed, the timing signal for the left eye being set to ON when the field for the left eye is displayed and to OFF when the field for the right eye is displayed,
the control method comprising:
controlling the pair of shutter glasses such that, in a period of the first subfield, both of the right eye shutter and the left eye shutter are in a closed state.
